(19) United States
(12) Patent Application Publication
(10) Pub. No.: US 2025/0226984 A1
(43) Pub. Date: Jul. 10, 2025

(54) PROVISIONING WITH SECURE SOFTWARE SUPPLY CHAIN DELIVERY

(71) Applicant: Lenovo Enterprise Solutions (Singapore) Pte. Ltd., New Tech Park (SG)

(72) Inventors: Fred Allison Bower, III, Durham, NC (US); Shyam Sareen, Cary, NC (US); Jarrod B. Johnson, Raleigh, NC (US)

(21) Appl. No.: 18/406,632

(22) Filed: Jan. 8, 2024

(51) Int. Cl. H04L 9/32; H04L 9/08

(52) U.S. Cl. CPC H04L 9/321; H04L 9/083

(57) ABSTRACT

A method for secure software supply chain delivery includes storing a vendor secret on a computing device while the computing device is at a manufacturer and querying, by a vendor cloud provisioner, the manufacturer for a serial number and a computing device secret. The method includes binding the computing device secret and the serial number and correlating a customer and provisioning instructions of the customer with the serial number of the computing device. The method includes receiving, from the computing device located where the computing device is to be provisioned, a request for the provisioning instructions, exchanging credentials between the computing device and the vendor cloud provisioner using the computing device secret and the vendor secret, and transmitting the provisioning instructions to the computing device in response a successful exchange of credentials between the computing device and the vendor cloud provisioner and/or receiving the serial number from the computing device.

### FIELD

The subject matter disclosed herein relates to software delivery and more particularly relates to secure software supply chain delivery.

### BACKGROUND

Computing devices shipped from a manufacturer often include some software installed. Typically, a customer buying and/or installing the software must customize software on the computing device once the computing device is being installed.

### BRIEF SUMMARY

A method for secure software supply chain delivery is disclosed. An apparatus and computer program product also perform the functions of the method. The method includes storing a vendor secret on a computing device while the computing device is located at a manufacturer of the computing device and querying, by a vendor cloud provisioner over a network, the manufacturer for a serial number of the computing device and a computing device secret. The method includes binding, in a provisioning data structure external to the computing device, the computing device secret and the serial number and correlating, in the provisioning data structure, a customer and provisioning instructions of the customer with the serial number of the computing device. The method includes receiving, from the computing device located at a location where the computing device is to be provisioned, a request for the provisioning instructions, exchanging credentials between the computing device and the vendor cloud provisioner using the computing device secret and the vendor secret, and transmitting the provisioning instructions to the computing device in response a successful exchange of credentials between the computing device and the vendor cloud provisioner and/or receiving the serial number from the computing device.

An apparatus for secure software supply chain delivery includes a processor and non-transitory computer readable storage media storing code. The code is executable by the processor to perform operations that include storing a vendor secret on a computing device while the computing device is located at a manufacturer of the computing device and querying, by a vendor cloud provisioner, the manufacturer for a serial number of the computing device and a computing device secret. The operations include binding, in a provisioning data structure external to the computing device, the computing device secret and the serial number, and correlating, in the provisioning data structure, a customer and provisioning instructions of the customer with the serial number of the computing device. The operations include receiving, from the computing device located at a location where the computing device is to be provisioned, a request for the provisioning instructions, exchanging credentials between the computing device and the vendor cloud provisioner using the computing device secret and the vendor secret, and transmitting the provisioning instructions to the computing device in response a successful exchange of credentials between the computing device and the vendor cloud provisioner and/or receiving the serial number from the computing device.

A program product for secure software supply chain delivery includes a non-transitory computer readable storage medium storing code. The code is configured to be executable by a processor to perform operations that include storing a vendor secret on a computing device while the computing device is located at a manufacturer of the computing device and querying, by a vendor cloud provisioner, the manufacturer for a serial number of the computing device and a computing device secret. The operations include binding, in a provisioning data structure external to the computing device, the computing device secret and the serial number, and correlating, in the provisioning data structure, a customer and provisioning instructions of the customer with the serial number of the computing device. The operations include receiving, from the computing device located at a location where the computing device is to be provisioned, a request for the provisioning instructions, exchanging credentials between the computing device and the vendor cloud provisioner using the computing device secret and vendor secret, and transmitting the provisioning instructions to the computing device in response a successful exchange of credentials between the computing device and the vendor cloud provisioner and/or receiving the serial number from the computing device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for secure software supply chain delivery, according to various embodiments;

FIG. 2 is a schematic block diagram illustrating a system flowchart for secure software supply chain delivery, according to various embodiments;

FIG. 3 is a schematic block diagram illustrating an apparatus for secure software supply chain delivery, according to various embodiments;

FIG. 4 is a schematic block diagram illustrating another apparatus for secure software supply chain delivery, according to various embodiments;

FIG. 5 is a schematic flow chart diagram illustrating a method for secure software supply chain delivery, according to various embodiments, according to various embodiments; and

FIG. 6 is a schematic flow chart diagram illustrating another method for secure software supply chain delivery, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for secure software supply chain delivery is disclosed. An apparatus and computer program product also perform the functions of the method. The method includes storing a vendor secret on a computing device while the computing device is located at a manufacturer of the computing device and querying, by a vendor cloud provisioner, the manufacturer for a serial number of the computing device and a computing device secret. The method includes binding, in a provisioning data structure external to the computing device, the computing device secret and the serial number and correlating, in the provisioning data structure, a customer and provisioning instructions of the customer with the serial number of the computing device. The method includes receiving, from the computing device located at a location where the computing device is to be provisioned, a request for the provisioning instructions, exchanging credentials between the computing device and the vendor cloud provisioner using the computing device secret and the vendor secret, and transmitting the provisioning instructions to the computing device in response a successful exchange of credentials between the computing device and the vendor cloud provisioner and/or receiving the serial number from the computing device.

In some embodiments, the method includes receiving from the customer, at the vendor cloud provisioner, the provisioning instructions for the computing device in response to verifying credentials of the customer. In other embodiments, the computing device includes a secure processor separate from a central processing unit of the computing device. The secure processor are configured to secure hardware of the computing device through integrated cryptographic keys where querying the computing device for the computing device secret and exchanging credentials between the vendor cloud provisioner and the computing device include querying the secure processor. In other embodiments, the secure processor includes a trusted platform module (“TPM”).

In some embodiments, receiving the request for the provisioning instructions from the computing device is in response to the computing device being powered on at the location where the computing device is to be provisioned. In other embodiments, the provisioning instructions include instructions to download and/or install firmware, an operating system, a software registration certificate, and/or an application. In other embodiments, correlating the provisioning instructions with the serial number of the computing device occurs when the computing device is located at a location different than where the computing device was manufactured and different from the location where the computing device is to be installed.

In some embodiments, the method includes correlating the serial number of the computing device with the customer. In other embodiments, the location where the computing device is to be provisioned is at a location where the customer is installing the computing device or a location of a trusted vendor that is provisioning the computing device for the customer. In other embodiments, the trusted vendor is correlated with the computing device at the vendor cloud provisioner and exchanging credentials between the computing device and the vendor cloud provisioner includes the trusted vendor providing credentials.

An apparatus for secure software supply chain delivery includes a processor and non-transitory computer readable storage media storing code. The code is executable by the processor to perform operations that include storing a vendor secret on a computing device while the computing device is located at a manufacturer of the computing device and querying, by a vendor cloud provisioner, the manufacturer for a serial number of the computing device and a computing device secret. The operations include binding, in a provisioning data structure external to the computing device, the computing device secret and the serial number, and correlating, in the provisioning data structure, a customer and provisioning instructions of the customer with the serial number of the computing device. The operations include receiving, from the computing device located at a location where the computing device is to be provisioned, a request for the provisioning instructions, exchanging credentials between the computing device and the vendor cloud provisioner using the computing device secret and the vendor secret, and transmitting the provisioning instructions to the computing device in response a successful exchange of credentials between the computing device and the vendor cloud provisioner and/or receiving the serial number from the computing device.

In some embodiments, the operations include receiving from the customer, at the vendor cloud provisioner, the provisioning instructions for the computing device in response to verifying credentials of the customer. In other embodiments, the computing device includes a secure processor separate from a central processing unit of the computing device. The secure processor is configured to secure hardware of the computing device through integrated cryptographic keys where querying the computing device for the computing device secret and exchanging credentials between the vendor cloud provisioner and the computing device include querying the secure processor.

In some embodiments, receiving the request for the provisioning instructions from the computing device is in response to the computing device being powered on at the location where the computing device is to be provisioned. In other embodiments, the provisioning instructions include instructions to download and/or install firmware, an operating system, a software registration certificate, and/or an application. In other embodiments, correlating the provisioning instructions with the serial number of the computing device occurs when the computing device is located at a location different than where the computing device was manufactured and different from the location where the computing device is to be installed. In other embodiments, the operations further include correlating the serial number of the computing device with the customer. In other embodiments, the location where the computing device is to be provisioned is at a location where the customer is installing the computing device or a location of a trusted vendor that is provisioning the computing device for the customer. In other embodiments, the trusted vendor is correlated with the computing device at the vendor cloud provisioner and exchanging credentials between the computing device and the vendor cloud provisioner includes the trusted vendor providing credentials.

A program product for secure software supply chain delivery includes a non-transitory computer readable storage medium storing code. The code is configured to be executable by a processor to perform operations that include storing a vendor secret on a computing device while the computing device is located at a manufacturer of the computing device and querying, by a vendor cloud provisioner, the manufacturer for a serial number of the computing device and a computing device secret. The operations include binding, in a provisioning data structure external to the computing device, the computing device secret and the serial number, and correlating, in the provisioning data structure, a customer and provisioning instructions of the customer with the serial number of the computing device. The operations include receiving, from the computing device located at a location where the computing device is to be provisioned, a request for the provisioning instructions, exchanging credentials between the computing device and the vendor cloud provisioner using the computing device secret and vendor secret, and transmitting the provisioning instructions to the computing device in response a successful exchange of credentials between the computing device and the vendor cloud provisioner and/or receiving the serial number from the computing device.

In some embodiments, the operations include receiving from the customer, at the vendor cloud provisioner, the provisioning instructions for the computing device in response to verifying credentials of the customer.

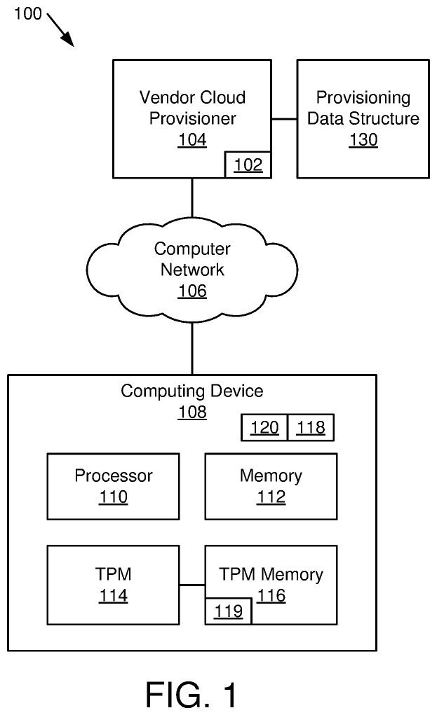

FIG. 1 is a schematic block diagram illustrating a system 100 for secure software supply chain delivery, according to various embodiments. The system 100 includes a vendor provisioning apparatus 102 in a vendor cloud provisioner 104 and connected to a provisioning data structure 130, a computer network 106, and a computing device 108 with a processor 110, memory 112, a trusted platform module (“TPM”) 114, and TPM memory 116 with a vendor provisioning agent 120, which are described below.

When a computing device 108 is shipped from a manufacturer, typically the computing device 108 includes generic software. Customization of software of the computing device 108 at the manufacturer is impractical because of the large amount of different software versions, types, customizations, etc. that the manufacturer would be required to have available and due to the fact that many computing devices 108 are sold to a store that sells the computing devices to customers so that the end customer is not known the manufacturer when the computing device 108 leaves the factory.

Another option is to prepare a portable storage device, such as a flash drive, sometimes called a thumb drive, or similar portable storage device with the required software. However, the logistics of managing security of the portable storage devices is a significant hurdle so that software distribution using a portable storage device is not an optimum solution for software distribution.

The most common method of provisioning a new computing device 108 at a customer location is to have a person sit at computing device 108 and manually download new software, drivers, subscriptions, etc. In many locations, the customer is not qualified to install software. For example, a petroleum company may have gas stations with a closet that includes computing devices 108 and the employees of the gas station are typically not qualified to install software. Having the gas station attendant try to call a system administrator for instructions is time consuming and may not result in a successful software installation. Alternatively, the system administrator can come to the gas station to provision a new computing device 108, which is problematic due to the costs involved and the time it takes to get a system administrator to the gas station.

The vendor provisioning apparatus 102 provides a way to use a computing device secret on a security processor of the computing device 108 along with secure processes to link the computing device 108 to a customer and to provisioning instructions. When the computing device 108 is first turned on, the computing device 108 contacts the vendor cloud provisioner 104 and the vendor provisioning apparatus 102 exchanges credentials with the vendor provisioning apparatus 102 using a secure process before transmitting provisioning instructions to the computing device 108. The provisioning instructions include links to software, installation instructions, subscription information, etc. so the software that the customer wants to run on the computing device 108 is properly installed. The vendor provisioning apparatus 102 is described in more detail below.

The vendor cloud provisioner 104 includes a computing device or server used by a vendor to correlate information about the computing device 108, such as a serial number, a cryptographic key matching a computing device secret, such as a security certificate and/or a cryptographic key, on the computing device 108, information about the customer that owns or leases the computing device 108, and/or provisioning instructions from the customer to provision the computing device 108. As used herein, provisioning the computing device 108 is a process of installing and commissioning software on the computing device 108 to meet requirements of the customer. The provisioning instructions are provided to the vendor cloud provisioner 104 prior to provisioning the computing device 108.

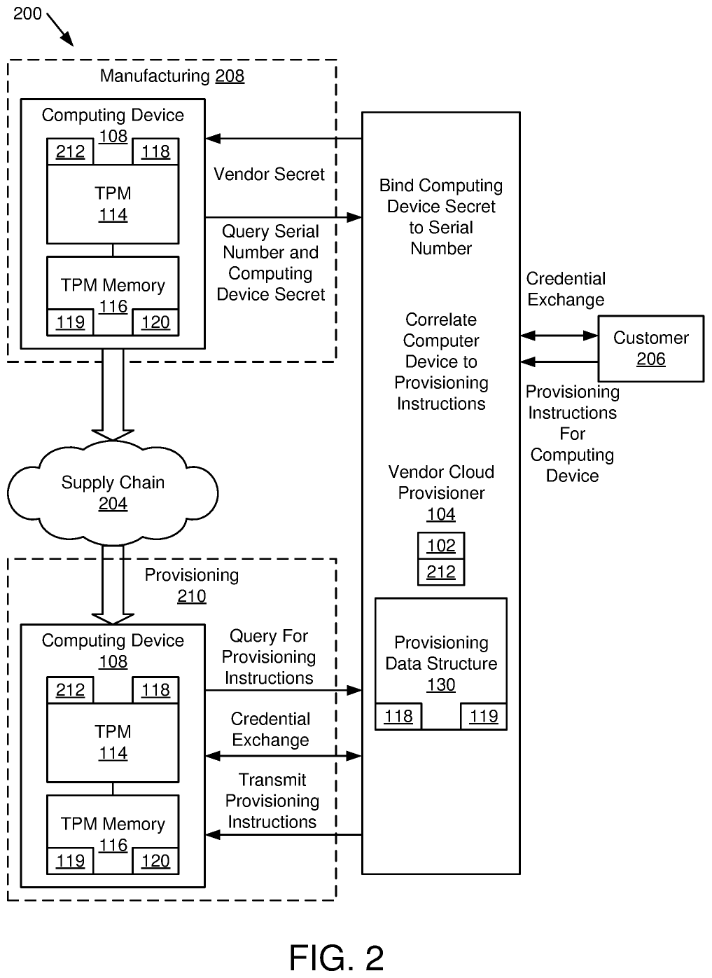

The vendor cloud provisioner 104, in some embodiments, is part of a cloud computing system and may utilize a rack-mounted server, a virtual machine, an application running in a container, a desktop computer, a mainframe computer, a workstation, or other server or combination of servers used to run the vendor provisioning apparatus 102. In some embodiments, the vendor cloud provisioner 104 uses a single computing device or virtual machine. In other embodiments, a vendor accesses a cloud computing system that manages the vendor provisioning apparatus 102 with various computing resources. While the vendor cloud provisioner 104 is depicted as one vendor cloud provisioner 104 in FIGS. 1 and 2, one of skill in the art will recognize that the vendor cloud provisioner 104 may include cloud computing resources assembled with various computing devices, storage systems, etc. As such, one server of the vendor cloud provisioner 104 may be used to access the computing device 108 at the manufacturer, another server of the vendor cloud provisioner 104 may be used to interact with a customer to receive provisioning instructions, another server of the vendor cloud provisioner 104 may be used to access the computing device 108 during provisioning, and each server of the vendor cloud provisioner 104 has access to the provisioning data structure 130. Use of a single vendor cloud provisioner 104 in FIGS. 1 and 2 and in the claims is merely for convenience.

The system 100 includes a computer network 106 that connects the computing device 108 with the vendor cloud provisioner 104. The computing device 108 starts at the manufacturer, which is typically a trusted location, and ends up at a customer location or a trusted vendor providing provisioning services for the computing device 108. Thus, the computer network 106 represents more than one network connection to the computing device 108 and may also include multiple networks. The computer network 106 may include a LAN, a WAN, a wireless connection, a fiberoptic network, a cellular network, the Internet, and any combination thereof. The computer network 106 includes various devices, such as switches, routers, cabling, servers, and the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The computing device 108 includes any computing device with a processor 110 and memory 112 along with a secure processor and associated memory where a security certificate, cryptographic keys, and the like may be stored and accessed in a secure way. In some embodiments, the secure processor is a trusted platform module (“TPM”) 114 connected to secured memory, e.g., TPM memory 116. In the embodiments of FIG. 1, the TPM memory 116 includes a vendor provisioning agent 120 and at least a serial number 118 of the computing device 108.

A trusted platform module (“TPM”), which is also known as an International Standards Association/International Electrotechnical Commission (“ISO/IEC”) 11889, is an international standard for a secure cryptoprocessor, which is a dedicated microcontroller designed to secure hardware, such as the computing device 108, through integrated cryptographic keys. TPM can also refer to a semiconductor chip that conforms to the ISO/IEC 11889 standard. The TPM or similar secure processor, in some embodiments, includes various features, such as a hardware random number generator, the ability for a secure generation of cryptographic keys for limited uses, and a hash key of the hardware and software configuration. The hash key provides a way to verify that the hardware and software have not been changed, which provides a mechanism to help ensure that the computing device 108 is secure with in the supply chain before reaching an installation location of the customer and/or a trusted provisioning provider.

In some embodiments, the TPM 114 encrypts data using a TPM binding key so that the computing device 108 is able to create cryptographic keys and encrypt them with the TPM binding key so that the cryptographic keys can only be decrypted by the TPM 114. This process is often called wrapping or binding a key and can help protect the key from disclosure. During manufacturing, hardware configuration information and the like can be stored by the TPM 114 or other secure processor on the TPM memory 116 or similar secure memory. As used herein, examples using “TPM” 114 also refer to other similar secure processors and/or secure processes used now or in the future, such as a next generation TPM or for other applications where a secure processor is not available so a secure processes is used with cryptographic keys to store data on the computing device 108.

Typically, the serial number 118 of the computing device 108 is not stored by the TPM 114, but is stored with vital product data and other information about the computing device 108. The serial number 118 is typically assigned during manufacturing and is stored in non-volatile memory. The non-volatile memory, in some embodiments, is different than other general purpose non-volatile memory of the computing device 108. In some embodiments, the serial number 118 is stored by the TPM 114 (or secure processor) and a security certificate, cryptographic key, or the like can be used to store and retrieve the serial number 118 and other configuration information.

In some embodiments, the TPM 114 generates and/or stores a computing device secret 119 which is used by the vendor cloud provisioner 104 to verify identity of the computing device 108. In some embodiments, the vendor cloud provisioner 104 binds the computing device secret 119 and the serial number 118 for use during provisioning of the computing device 108. In some embodiments, the computing device secret 119 is a security certificate. In other embodiments, the computing device secret 119 is a cryptographic key, such as a private key paired with a public key possessed by the vendor cloud provisioner 104. In other embodiments, the computing device secret 119 is part of symmetric cryptographic keys shared between the computing device 108 and the vendor cloud provisioner 104. In other embodiments, the computing device secret 119 is an application program interface (“API”) token used to identify the computing device 108. One of skill in the art will recognize other forms for the computing device secret 119 that may be used by the vendor cloud provisioner 104 to verify identity of the computing device 108.

In some embodiments, the vendor provisioning agent 120 is an API that allows the vendor provisioning apparatus 102 to exchange the serial number 118, the computing device secret 119, security certificates, etc. using the processor 110 and/or the TPM 114, to receive provisioning instructions, and the like. Note that the vendor provisioning agent 120 is depicted external to the TPM memory 116. In other embodiments, all or a portion of the vendor provisioning agent 120 is stored elsewhere on the computing device 108, such as in the TPM memory 116, on a non-volatile storage device on the computing device 108 and some or all of the vendor provisioning agent 120 is loaded into memory 112 of the computing device 108 for execution by the processor 110.

The system 100 includes a provisioning data structure 130 capable of storing the serial number 118 of the computing device 108, a computing device secret 119, information about a customer that owns the computing device 108, provisioning instructions, and other information relevant to provisioning the computing device 108. The provisioning data structure 130, in various embodiments, includes a table, a list, a data array, a database, or other data structure that allows the computing device key and the serial number 118, the computing device secret 119, the provisioning instructions, customer information, manufacturing information, etc. to be bound together, such as in a common line of the table, in a data structure for the computing device 108 that is part of a larger database for computing devices, etc. In some embodiments, the provisioning data structure 130 is capable of adding customer information, the provisioning instructions, etc. at various steps of a supply chain.

The provisioning data structure 130, in some embodiments, is available in a cloud computing environment. In some embodiments, the provisioning data structure 130 is part of a storage area network (“SAN”) or other non-volatile data storage solution that provides robust and secure data storage in a way that is accessible from the manufacturer, from a computing device vendor, from a customer, or other location in a supply chain.

FIG. 2 is a schematic block diagram illustrating a system flowchart 200 for secure software supply chain delivery, according to various embodiments. The system flowchart 200 shows the computing device 108 during manufacturing 208 and then during provisioning 210 at a customer location where the computing device 108 will be stored or at a trusted vendor that is provisioning the computer for the customer 206. Initially during manufacturing 208, the computing device 108 reaches a point in manufacturing, which is usually when nearing completion, where a serial number 118 is assigned to the computing device 108 and written non-volatile memory.

In addition to the serial number 118, a vendor secret 212 is also stored on the computing device 108 identifying the vendor. In some embodiments, the vendor secret 212 stores additional information, such as a website of the vendor, an identifier of a process of the vendor cloud provisioner 104, or other information linked to the vendor cloud provisioner 104 to enable the computing device 108 to validate the vendor cloud provisioner 104. The vendor secret 212, in various embodiments, is a security certificate, one of a pair of cryptographic keys, an API token, or other data structure that may be used to validate the vendor cloud provisioner 104 to the computing device 108. By storing the vendor secret 212 on the computing device 108, the vendor provisioning agent 120 is able to compare information in the vendor secret 212 with credentials presented by the vendor cloud provisioner 104 at the time of provisioning.

The computing device 108 also includes the computing device secret 119 as described above. In some embodiments, the computing device secret 119 is a security certificate. In other embodiments, the computing device secret 119 includes information relevant to the computing device 108, such as date of manufacture, location of manufacture, and the like. The computing device secret 119, in some embodiments, is stored using a cryptographic key. Writing a serial number 118 to a computing device 108 is a typical step for most computing devices 108.

The vendor provisioning apparatus 102 queries the manufacturer 208 of the computing device 108 for the serial number 118 and the computing device secret 119. In some embodiments, the manufacturer 208 includes a database with serial numbers of computing devices, including the computing device 108 in FIG. 2, and the manufacturer 208 provides the serial number 118 and computing device secret 119 from the database. In other embodiments, the manufacturer 208 queries the computing device for the serial number 118 and the computing device secret 119 and relays the serial number 118 and the computing device secret 119 to the vendor cloud provisioner 104/vendor provisioning apparatus 102. Typically, a manufacturer 208 would not allow direct access to a computing device 108 by an outside device. However, an option of the vendor provisioning apparatus 102/vendor cloud provisioner 104 querying the computing device 108 for the serial number 118 and computing device secret 119 may also be included in some embodiments.

and the vendor provisioning apparatus 102 binds the serial number 118 to the computing device secret 119 within a provisioning data structure 130 accessible to the vendor cloud provisioner 104. The vendor cloud provisioner 104 includes one or more vendor provisioning servers and refers to a service for securely storing the serial number 118, computing device secret 119, customer identification information, cryptographic keys for the computing device 108, provisioning instructions, etc. useful in securely and correctly providing provisioning instructions to the computing device 108 that are specified by the customer 206.

In some embodiments, the customer 206 that will own or lease the computing device 108 is known at the time of manufacturing 208 of the computing device 108. In other embodiments, the computing device 108 is sold to a vendor of computing equipment, which then in turn sells the computing device 108 to the customer 206 so that the identity of the customer 206 is known after manufacturing 208 during the supply chain process 204. The system flowchart 200 depicts a customer 206. In some embodiments, the customer 206 exchanges credentials with the vendor cloud provisioner 104 to securely identify the customer 206 to the vendor cloud provisioner 104 and to securely identify the vendor cloud provisioner 104 to the customer 206. In response to a successful credential exchange between the vendor cloud provisioner 104 and the customer 206, the customer 206 provides provisioning instructions for the computing device 108. The customer 206 and the provisioning instructions of the customer 206 are correlated with the serial number of the computing device 108. In some embodiments, the provisioning instructions are specific to the computing device 108. In other embodiments, the provisioning instructions are general instructions for several computing devices 108 of the customer 206.

The supply chain 204 includes steps, companies, etc. involved with getting the computing device 108 from manufacturing 208 to a provisioning location 210. Some of the steps of the supply chain 204 include transferring the computing device 108 from the manufacturer to a shipping company, from the shipping company to a retail vendor that will sell the computing device 108, from retail vendor to another shipping company, which transports the computing device 108 to the customer 206 or to a trusted vendor that will provision the computing device 108 before moving the computing device 108 to a location of installation of the customer 206. The supply chain 204 may include additional steps, such as a sale and transport to a wholesaler, shipping to a warehouse, or other steps between initial manufacturing 208 and a provisioning location 210. Typically, once the computing device 108 is shipped after manufacturing 208, the computing device 108 is not accessed until provisioning 210.

In some embodiments, the computing device 108 includes additional manufacturing steps, such as customization of hardware, etc. where the computing device 108 is accessed before provisioning by the customer 206. In such embodiments, the vendor provisioning apparatus 102 may bind additional information regarding the intermediate manufacturing step to the serial number 118 in the provisioning data structure 130. Steps associated with this additional manufacturing step may also be recorded by the TPM 114 as part of a chain of custody so that credential exchange during provisioning does not fail.

In other embodiments, manufacturing partners, the customer 206, or other trusted entities are known at the time of manufacturing 208 and each party registers a secret similar to the vendor secret 212 with the computing device 108. During provisioning, the vendor provisioning agent 120 contacts the trusted parties that have registered a secret for provisioning instructions.

During provisioning 210, the computing device 108 queries the vendor cloud provisioner 104 for provisioning instructions. In some embodiments, the query occurs upon power-on of the computing device 108, upon connection of the computing device 108 to the computer network 106, etc. In other embodiments, a user directs the computing device 108 to request the provisioning instructions. In some embodiments, the vendor provisioning agent 120 initiates the query for the provisioning instructions.

In response to the query for the provisioning instructions, the computing device 108, through the TPM 114 and/or vendor provisioning agent 120, and the vendor cloud provisioner 104, through the vendor provisioning apparatus 102, exchange credentials. In some embodiments, the vendor provisioning agent 120 and/or the computing device 108 provide the computing device secret 119 as proof of identity to the vendor cloud provisioner 104 and receives back the vendor secret 212 for an exchange of credentials. In other embodiments, the computing device 108 provides the serial number 118 while the vendor cloud provisioner 104 provides information to identify the customer 206 and/or that the vendor cloud provisioner 104 is authorized. In some embodiments, the credential exchange is by way of the vendor cloud provisioner 104 providing one or more cryptographic keys and, in response, the TPM 114 provides the serial number 118 of the computing device 108.

In response, the vendor provisioning apparatus 102, through the vendor cloud provisioner 104, provides the provisioning instructions to the computing device 108. In some embodiments, the vendor cloud provisioner 104 encrypts the provisioning instructions and the computing device 108 uses a cryptographic key in the vendor secret 212 or computing device secret 119 or other cryptographic key that the vendor cloud provisioner 104 knows that the computing device 108 has to decrypt the provisioning instructions. The computing device 108 then uses the provisioning instructions to access one or more websites with firmware and/or software to be installed on the computing device 108, installs the firmware/software, installs drivers, installs software certificates, etc. so that the computing device 108 is provisioned according to the provisioning instructions of the customer 206.

In embodiments where more than one trusted party registered with the computing device 108, the computing device 108 queries each of the trusted parties for provisioning instructions and then goes through a credential exchange before receiving provisioning instructions. Beneficially, the vendor provisioning apparatus 102 and associated vendor provisioning agent 120 provide a convenient and secure way to provision the computing device 108 without a system administrator needing to be at the computing device 108 or the computing device 108 being preloaded with software/firmware that most likely will be obsolete at the time of activation of the computing device 108.

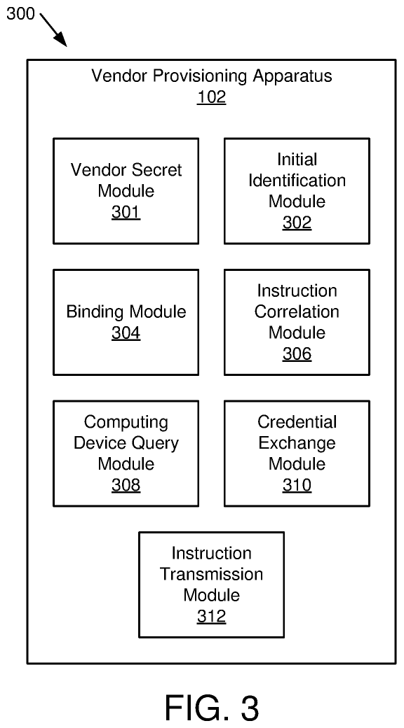

FIG. 3 is a schematic block diagram illustrating an apparatus 300 for secure software supply chain delivery, according to various embodiments. The apparatus 300 includes a vendor provisioning apparatus 102 with a vendor secret module 301, an initial identification module 302, a binding module 304, an instruction correlation module 306, a computing device query module 308, a credential exchange module 310, and an instruction transmission module 312, which are described below. In some embodiments, the apparatus 300 is implemented using executable code stored on computer readable storage media. In other embodiments, all or a portion of the apparatus 300 is implemented using a programmable hardware device and/or hardware circuits.

The apparatus 300 includes a vendor secret module 301 configured to store a vendor secret 212 on a computing device 108 while the computing device 108 is located at a manufacturer 208 of the computing device 108. In some embodiments, the vendor secret module 301 stores the vendor secret 212 as part of an exchange with the computing device 108 to get a serial number 118 and/or a computing device secret 119. In other embodiments, because the computing device 108 is in a trusted environment at the manufacturer 208, the vendor secret module 301 accesses the computing device 108 and stores the vendor secret 212. In other embodiments, the vendor secret module 301 alerts the computing device 108 about storing the vendor secret 212 and the vendor provisioning agent 120 and/or computing device 108 stores the vendor secret 212.

The apparatus 300 includes an initial identification module 302 configured to query, by a vendor cloud provisioner 104, the manufacturer 208 of the computing device 108 for a serial number 118 of the computing device 108 and a computing device secret 119. In some embodiments, the initial identification module 302 queries the manufacturer 208 while the computing device 108 is located at a manufacturer 208 of the computing device 108. In other embodiments, the initial identification module 302 queries the manufacturer 208 while the computing device 108 is not at the manufacturer 208, for example when the computing device 108 is being stored in a warehouse, is at a vendor, etc.

In some embodiments, the serial number 118 and the computing device secret 119 are stored in a computing device database. The computing device database, in various embodiments, includes serial numbers and device secrets of numerous computing devices that are being or have been manufactured by the manufacturer 208. In other embodiments, the computing device database includes other relevant data, such as configuration data, software data, a hardware list, a manufacturing status, a location, etc. of the various computing devices. In some embodiments, the vendor secret module 301 and the initial identification module 302 act in response to a customer request for a computing device 108 with particular specifications. In other embodiments, the vendor secret module 301 and the initial identification module 302 coordinate with the manufacturer 208 to store serial numbers and computing device secrets and/or other computing device data prior to the computing devices being selected by a customer 206.

In some embodiments, the query includes the manufacturer 208 accessing a security certificate on the computing device 108 where the security certificate is associated with the serial number 118 of the computing device 108 and, in some embodiments, indicates an identity of the manufacturer 208. In other embodiments, the security certificate includes other relevant information, such as a location of the manufacturer 208, a date of manufacture, configuration information of the computing device 108, and the like. In some embodiments, the security certificate is the computing device secret 119. In other embodiments, the computing device secret 119 is separate from the security certificate and the computing device secret 119 is suitable to transmit to the vendor cloud provisioner 104 for later credential exchange with the computing device 108.

Typically, the security certificate and/or the computing device secret 119 of the computing device 108 was previously installed on the computing device 108 during manufacturing 208 along with the serial number. In some embodiments, the TPM 114 generates the security certificate and/or computing device secret 119. The initial identification module 302, in some embodiments, communicates with a TPM 114 of the computing device 108 to interact with the security certificate and/or computing device secret 119 of the computing device 108, which results in receiving the serial number 118 of the computing device 108. In some embodiments, the initial identification module 302 also receives additional information, such as the identity of the manufacturer 208, date or manufacture, etc., which may help to verify that the computing device 108 is legitimate. In some embodiments, the initial identification module 302 compares the serial number 118 along with information from the security certificate of the computing device 108 and/or the computing device secret 119 with a database containing the serial number 118 and other information, such as date of manufacture, location of manufacture, etc. to verify the identity of the computing device 108.

In some embodiments, the initial identification module 302 queries the computing device 108 at the time the computing device 108, security certificate, and/or the computing device secret 119 are written to the computing device 108 as part of a validation process. In other embodiments, the initial identification module 302 queries the computing device 108 at a later time, for example when the serial number 118 is to be bound to the computing device secret 119.

The apparatus 300 includes a binding module 304 configured to bind, in the provisioning data structure 130 external to the computing device 108, a computing device secret 119 of the computing device 108 and the serial number 118. The computing device secret 119, in some embodiments, is a cryptographic key that may be used with the security certificate and/or computing device secret 119 on the computing device 108 to access information stored by the TPM 114 on the computing device 108. The binding module 304 binding the serial number 118 with the computing device secret 119, in some embodiments, includes storing the computing device secret 119 and the serial number 118 in the provisioning data structure 130 that allows the computing device secret 119 and the serial number 118 to be bound together, associated together, etc.

The apparatus 300 includes an instruction correlation module 306 configured to correlate, in the provisioning data structure 130, a customer 206 and provisioning instructions of the customer 206 with the serial number 118 of the computing device 108. The provisioning instructions are associated with a customer 206. In some embodiments, the customer 206 is assigned a customer number and the customer number is correlated with the provisioning instructions, the serial number 118, and the computing device secret 119. In other embodiments, information about the customer 206 is part of the provisioning instructions so that the customer 206 is correlated with the serial number 118 and the computing device secret 119 by correlating the provisioning instructions. In some embodiments, the provisioning instructions are received from the customer 206 for the computing device 108. In other embodiments, the provisioning instructions are provided by the customer 206 for two or more computing devices 108 of the customer 206, for a particular location, for a particular type of computing device, or other general provisioning instructions from the customer 206. For example, the customer 206 may be a petroleum company and may have certain provisioning instructions for each gas station that they own and may have different provisioning instructions for a datacenter owned by the petroleum company. In other embodiments, the provisioning instructions are customized specifically for the computing device 108.

In some embodiments, the instruction correlation module 306 corelates the provisioning instructions with the serial number 118 of the computing device by adding the provisioning instructions or a link to the provisioning instructions to the provisioning data structure 130 where the computing device secret 119 and serial number 118 are bound. In some embodiments, the provisioning data structure 130 with the serial number 118, computing device secret 119, and provisioning instructions (or links to the provisioning instructions and computing device secret 119) are part of a cloud-based solution accessible by the computing device 108 over the computer network 106.

The provisioning instructions, in various embodiments, include instructions to download and/or install firmware, an operating system, a software registration certificate, and/or an application. In other embodiments, the provisioning instructions include instructions to authorize firmware and/or software installed on the computing device 108. In other embodiments, the provisioning instructions include executable code that automates provisioning the computing device 108. In some examples, the executable code includes an installation sequence. For example, the installation sequence may install the operating system on the computing device 108 before installing applications that run on the operating system. In other embodiments, the provisioning instructions include information for a user of the computing device 108 after provisioning, such as software versions, firmware versions, etc. One of skill in the art will recognize other information, instructions, code, etc. to include in provisioning instructions.

The apparatus 300 includes a computing device query module 308 configured to receive, from the computing device 108 located at a location where the computing device 108 is to be provisioned, a request for the provisioning instructions. In some embodiments, the computing device query module 308 is received at a time when the computing device 108 is first plugged in, is first connected to the computer network 106, or the like. In other embodiments, the computing device query module 308 receives the query for the provisioning instructions in response to user input at the computing device 108.

In some embodiments, the location where the computing device 108 is being provisioned is at a final location of the customer 206 where the customer 206 is installing the computing device 108 and is to be used. In other embodiments, the location where the computing device 108 is being provisioned is at a location of a trusted vendor that is provisioning the computing device 108 for the customer 206. In some examples, the trusted vendor is a company that provides provisioning services, which may be at a site owned or controlled by the trusted vendor. The trusted vendor then sends or delivers the computing device to the customer 206.

In some embodiments, the computing device query module 308 receives a query from the computing device 108 that includes an identifier for the computing device 108, such as the serial number 118, the computing device secret 119, or the like so that the vendor provisioning apparatus 102 is able to check for specific provisioning instructions for the computing device 108. In other embodiments, the query from the computing device 108 is a general inquiry that starts a credential exchange between the computing device 108 and the vendor cloud provisioner 104. In some embodiments, the query from the computing device 108 includes the computing device secret 119 without the serial number 118 to initiate a credential exchange with the vendor cloud provisioner 104.

The apparatus 300 includes a credential exchange module 310 configured to exchange credentials between the computing device 108 and the vendor cloud provisioner 104 using the computing device secret 119 and the vendor secret 212. In some embodiments, the credential exchange module 310 exchanges credentials using the TPM 114 of the computing device 108. In some embodiments, the TPM 114 provides the computing device secret 119 to the vendor cloud provisioner 104 and the credential exchange module 310 uses the computing device secret 119 provided by the TPM 114 along with the computing device secret 119 stored in the provisioning data structure 130 to validate the computing device 108. In other examples, the vendor cloud provisioner 104 provides the computing device secret 119 to the TPM 114, which uses the computing device secret 119 along with a cryptographic key of the security certificate of the computing device 108 to validate the identity of the computing device 108 to enable access of the serial number 118 of the computing device 108.

In other embodiments, the TPM 114 provides additional information, such as the manufacturer of the computing device 108 and/or additional information about manufacturing the computing device 108. In some embodiments, the credential exchange module 310 uses the serial number 118 and, in some cases, additional information from the computing device 108 to compare with similar information in an entry for the computing device 108 in the provisioning data structure 130 and then verifies that the provided information matches the stored information.

In some embodiments, the credential exchange module 310 exchanges credentials by providing the vendor secret 212 to the computing device 108 and/or TPM 114 and the TPM 114/computing device 108 uses the vendor secret 212 stored on the computing device 108 to compare with the received vendor secret 212 to validate the vendor cloud provisioner 104. In some embodiments, the credential exchange module 310 providing the vendor secret 212 provides enough information for the computing device 108 to trust the vendor cloud provisioner 104. In other embodiments, the credential exchange module 310 provides additional information to the computing device 108 as part of the credential exchange, such as the manufacturer, the date of manufacture, etc. and the TPM 114 and/or vendor provisioning agent 120 compares this information with information in the security certificate of the computing device 108 and if the information provided by the vendor cloud provisioner 104 matches information in the security certificate, the TPM 114 and/or vendor provisioning agent 120 trusts the vendor cloud provisioner 104 and provides the serial number 118 and/or other credential information.

Where provisioning of the computing device 108 is done by a trusted vendor, the trusted vendor is correlated to the computing device 108 and/or serial number 118 of the computing device 108. In some embodiments, the customer 206 provides information to the vendor cloud provisioner 104 about the trusted vendor. In some embodiments, the information about the trusted vendor is received with or in the provisioning instructions. In other embodiments, the information about the trusted vendor is provided separate from the provisioning instructions. In the embodiments, the credential exchange module 310 exchanging credentials between the computing device 108 and the vendor cloud provisioner 104 includes the trusted vendor providing credentials, which may be through the computing device 108 or another computing device. For example, when the trusted vendor is provisioning the computing device 108, the trusted vendor may provide credentials that match information provided by the customer 206 about the trusted vendor.

The apparatus 300 includes an instruction transmission module 312 configured to transmit the provisioning instructions to the computing device 108 in response a successful exchange of credentials between the computing device 108 and the vendor cloud provisioner 104 and/or receiving the serial number 118 from the computing device 108. In some embodiments, the successful exchange of credentials includes the computing device 108/TPM 114 transmitting the computing device secret 119, which is bound to the serial number 118 of the computing device 108, which is sufficient for the instruction transmission module 312 to transmit the provisioning instructions. In other embodiments, the successful exchange of credentials between the computing device 108 and the vendor cloud provisioner 104 triggers the computing device 108 and/or the vendor provisioning agent 120 to transmit the serial number 118 to the vendor cloud provisioner 104. The computing device 108, in response to receiving the provisioning instructions, proceeds with provisioning the computing device 108 according to the provisioning instructions.

In some embodiments, the successful exchange of credentials includes the computing device secret 119 being a correct key to access the security certificate of the computing device 108. In other embodiments, the successful exchange of credentials includes the computing device 108 receiving information, such as the manufacturer, the date of manufacture, or the like matching what is in the security certificate of the computing device 108. In other embodiments, the successful exchange of credentials includes the vendor cloud provisioner 104 receiving the serial number 118 and/or information from the security certificate that matches information in the database for the computing device 108 that is stored in the provisioning data structure 130.

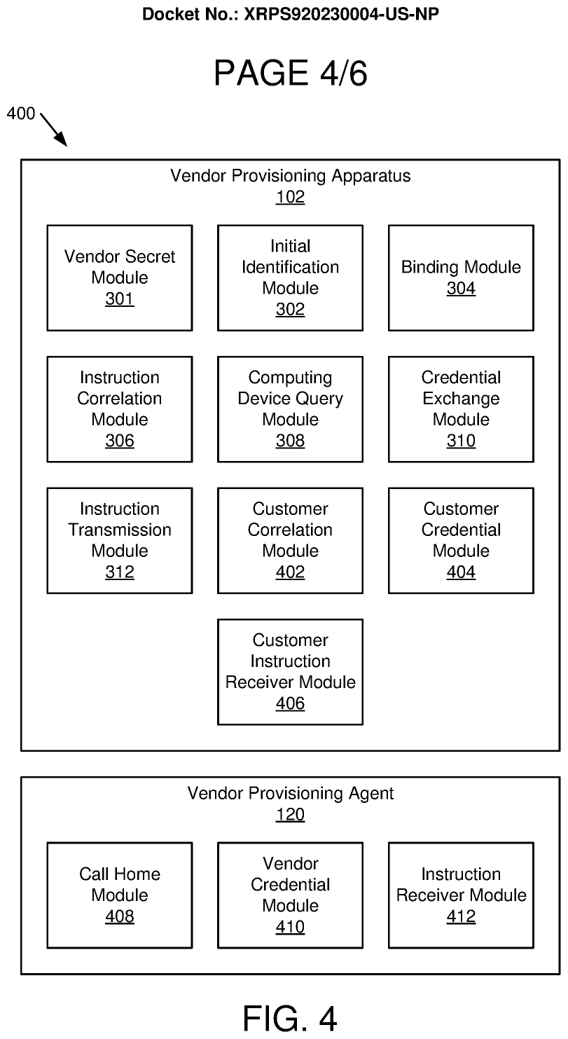

FIG. 4 is a schematic block diagram illustrating another apparatus 400 for secure software supply chain delivery, according to various embodiments. The apparatus 400 includes another version of the vendor provisioning apparatus 102 with the vendor secret module 301, the initial identification module 302, the binding module 304, the instruction correlation module 306, the computing device query module 308, the credential exchange module 310, and the instruction transmission module 312, which are substantially similar to those described above in relation to the apparatus 300 of FIG. 3. The apparatus 400, in various embodiments, includes a customer correlation module 402, a customer credential module 404 and/or a customer instruction receiver module 406 in the vendor provisioning apparatus 102 and a vendor provisioning agent 120 with a call home module 408, a vendor credential module 410, and/or an instruction receiver module 412, which are described below. In some embodiments, the apparatus 400 is implemented using executable code stored on computer readable storage media. In other embodiments, all or a portion of the apparatus 400 is implemented using a programmable hardware device and/or hardware circuits.

In some embodiments, the vendor provisioning apparatus 102 includes a customer correlation module 402 configured to correlate the serial number 118 of the computing device 108 with the customer 206. In some embodiments, the customer correlation module 402 correlates the serial number 118 of the computing device 108 with the customer 206 when the customer 206 purchases the computing device 108 after manufacturing 208 of the computing device 108. In some examples, a computing device vendor may finalize a sale of the computing device 108 to the customer 206 and may then send information about the customer 206 to the vendor cloud provisioner 104 to be stored on the provisioning data structure 130 in a record for the computing device 108.

In other embodiments, the computing device vendor accesses the data structure correlating the serial number 118 and computing device secret 119 to add the customer 206 to an entry for the computing device 108 in the provisioning data structure 130. In other embodiments, the computing device vendor sends information regarding the sale of the computing device 108 to the customer 206 and a system administrator, a user, etc. accesses a user interface of the customer correlation module 402 to enter customer data to the entry for the computing device 108 in the provisioning data structure 130. One of skill in the art will recognize other ways for the customer correlation module 402 to correlate the serial number 118 of the computing device 108 to the customer 206.

In some embodiments, the customer correlation module 402 correlates the customer 206 with the serial number 118 of the computing device 108 prior to or during manufacturing 208 of the computing device 108. In other embodiments, the customer correlation module 402 correlates the serial number 118 of the computing device 108 with the customer 206 after completion of manufacturing 208 of the computing device 108.

In some embodiments, the vendor cloud provisioner 104 includes a customer credential module 404 configured to verify credentials of the customer 206. In some embodiments, the customer credential module 404 uses cryptographic keys to verify identity of the customer 206. In other embodiments, the customer credential module 404 receives information from the customer 206 and correlates the received information about the customer 206 with known information about the customer 206. One of skill in the art will recognize other ways to verify credentials of the customer 206.

In some embodiments, the vendor provisioning apparatus 102 includes a customer instruction receiver module 406 configured to receive from the customer 206, at the vendor cloud provisioner 104, the provisioning instructions for the computing device 108 in response to the customer credential module 404 verifying credentials of the customer 206. First verifying credentials of the customer 206 is important for verifying validity of the provisioning instructions to make sure that the provisioning instructions are truly from the customer 206 and not from a malicious source. In some embodiments, the provisioning instructions from the customer 206 include the serial number 118 of the computing device 108. In other embodiments, the customer 206 includes other information to identify the computing device 108 instead of the serial number 118, such as a sale receipt where the sales receipt is correlated with the computing device 108 and/or serial number 118.

In some embodiments, the vendor provisioning agent 120 includes a call home module 408 configured to transmit a request for provisioning instructions for the computing device 108. In some embodiments, the call home module 408 includes a website address or other contact information of the vendor cloud provisioner 104 to be used in the request. In some embodiments, the call home module 408 transmits the request for provisioning instructions for the computing device 108 upon power-on of the computing device 108, for example, when a user plugs in the computing device 108. In other embodiments, the call home module 408 transmits the request for provisioning instructions for the computing device 108 upon connection of the computing device 108 to a computer network 106 connected to the vendor cloud provisioner 104. In other embodiments, the call home module 408 transmits the request for provisioning instructions for the computing device 108 in response to direction from a user at the computing device 108. One of skill in the art will recognize other ways for the call home module 408 to initiate transmission of the request for provisioning instructions for the computing device 108.

In some embodiments, the vendor provisioning agent 120 includes a vendor credential module 410 configured to exchange credentials with the vendor cloud provisioner 104. In some embodiments, the vendor credential module 410 transmits the computing device secret to the vendor cloud provisioner 104 for validation of the computing device 108 at the vendor cloud provisioner 104. In some embodiments, the vendor credential module 410 receives the vendor secret 212 from the vendor cloud provisioner 104 for comparison with the vendor secret 212 stored on the computing device 108 to validate the vendor cloud provisioner 104.

In some embodiments, the vendor credential module 410 rejects information from the vendor cloud provisioner 104 and/or sends an alert to the vendor cloud provisioner 104 and/or to a system administrator in response to information in the received vendor secret 212 not being a match with information in the vendor secret 212 stored on the computing device 108. In other embodiments, the vendor credential module 410 transmits the serial number 118 of the computing device 108 to the vendor cloud provisioner 104 and/or other information about the computing device 108 in response to information in the received vendor secret 212 matching information from the vendor secret 212 stored on the computing device 108. In some embodiments, in response to the vendor secret 212 unlocking (e.g., decrypting) information in the security certificate on the computing device 108 or at least matching the information of the stored vendor secret 212, the vendor credential module 410 trusts the vendor cloud provisioner 104 and allows information from the vendor cloud provisioner 104 to be stored, executed, acted upon, etc.

The vendor provisioning agent 120, in some embodiments, includes an instruction receiver module 412 configured to receive the provisioning instructions from the vendor cloud provisioner 104. In some embodiments, the instruction receiver module 412 receives the provisioning instructions and makes the provisioning instructions available to at a basic input/output system (“BIOS”), unified extensible firmware interface (“UEFI”), etc. or to a management controller (e.g., baseboard management controller (“BMC”), Xclarity Controller® by Lenovo® (“XCC”), etc.) to execute the provisioning instructions, which typically results in provisioning the computing device 108. In some embodiments, the received provisioning instructions are encrypted and the instruction receiver module 412 uses a key in the computing device secret 119 or vendor secret 212 to decrypt the provisioning instructions.

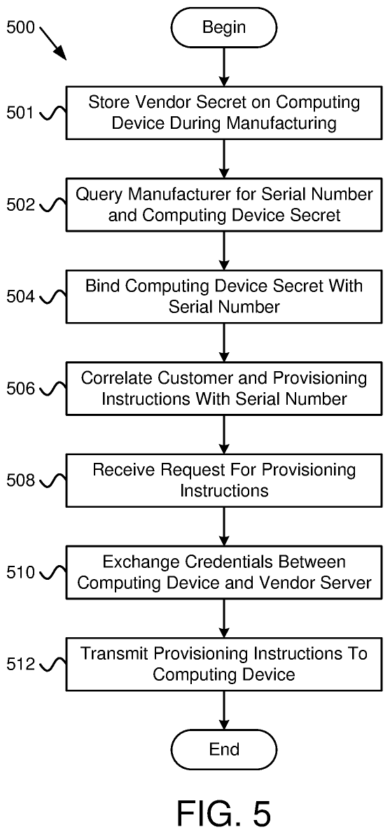

FIG. 5 is a schematic flow chart diagram illustrating a method 500 for secure software supply chain delivery, according to various embodiments, according to various embodiments. The method 500 begins and stores 501 a vendor secret 212 on a computing device 108 while the computing device 108 is located at a manufacturer 208 of the computing device 108 and queries 502, by a vendor cloud provisioner 104, the manufacturer 208 of the computing device 108 for a serial number 118 of the computing device 108 and a computing device secret 119. In some embodiments, the method 600 queries 502 the manufacturer 208 while the computing device 108 is located at a manufacturer. In other embodiments, the method 600 queries 502 the manufacturer 208 for the serial number 118 and the computing device secret 119 while the computing device 108 is at a different location.

The method 500 binds 504, in a provisioning data structure 130 external to the computing device 108, a computing device secret 119 of the computing device 108 and the serial number 118 and correlates 506, in the provisioning data structure 130, the customer 206 and provisioning instructions with the serial number 118 of the computing device 108. The provisioning instructions are associated with a customer 206. The method 500 receives 508 a request for the provisioning instructions from the computing device 108 located at a location where the computing device 108 is to be provisioned.

The method 500 exchanges 510 credentials between the computing device 108 and the vendor cloud provisioner 104 using the computing device secret 119 and the vendor secret 212. The method 500 transmits 512 the provisioning instructions to the computing device 108 in response a successful exchange of credentials between the computing device 108 and the vendor cloud provisioner 104 and/or receiving the serial number 118 from the computing device 108, and the method 500 ends. In various embodiments, all or a portion of the method 500 is implemented using the vendor secret module 301, the initial identification module 302, the binding module 304, the instruction correlation module 306, the computing device query module 308, the credential exchange module 310, and/or the instruction transmission module 312.

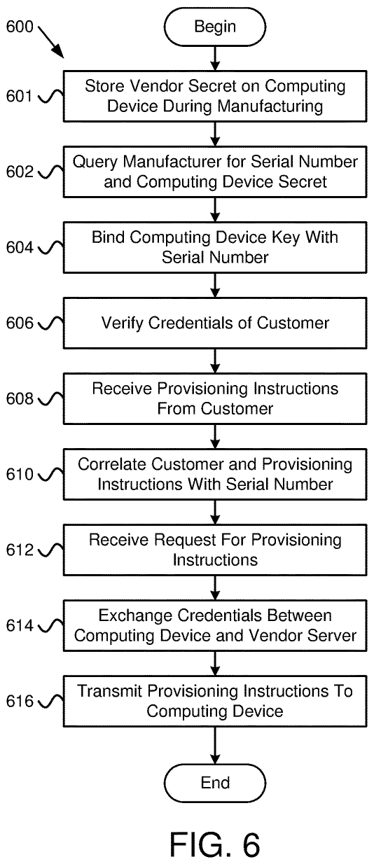

FIG. 6 is a schematic flow chart diagram illustrating another method 600 for secure software supply chain delivery, according to various embodiments. The method 600 begins and stores 601 a vendor secret 212 on a computing device 108 while the computing device 108 is located at a manufacturer 208 of the computing device 108 and queries 602, by a vendor cloud provisioner 104, the manufacturer 208 of the computing device 108 for a serial number 118 of the computing device 108 and a computing device secret 119. In some embodiments, the method 600 queries 502 the manufacturer 208 while the computing device 108 is located at a manufacturer 206. In other embodiments, the method 600 queries 502 the manufacturer 208 for the serial number 118 and the computing device secret 119 while the computing device 108 is at a different location. The method 600 binds 604, in a provisioning data structure 130 external to the computing device 108, a computing device secret 119 of the computing device 108 and the serial number 118.

The method 600 verifies 606 credentials of a customer 206 purchasing or leasing the computing device 108 and receives 608 provisioning instructions from the customer 206. The method 600 correlates 610, in the provisioning data structure 130, the customer 206 and provisioning instructions with the serial number 118 of the computing device 108. The method 600 receives 612 a request for the provisioning instructions from the computing device 108 located at a location where the computing device 108 is to be provisioned.

The method 600 exchanges 614 credentials between the computing device 108 and the vendor cloud provisioner 104 using the computing device secret 119 and the vendor secret 212. The method 600 transmits 616 the provisioning instructions to the computing device 108 in response a successful exchange of credentials between the computing device 108 and the vendor cloud provisioner 104 and/or receiving the serial number 118 from the computing device 108, and the method 600 ends. In various embodiments, all or a portion of the method 600 is implemented using the vendor secret module 301, the initial identification module 302, the binding module 304, the instruction correlation module 306, the computing device query module 308, the credential exchange module 310, the instruction transmission module 312, the customer correlation module 402, the customer credential module 404 and/or the customer instruction receiver module 406 in the vendor provisioning apparatus 102 and/or the call home module 408, the vendor credential module 410, and/or the instruction receiver module 412 in the vendor provisioning agent 120.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
storing a vendor secret on a computing device while the computing device is located at a manufacturer of the computing device;
querying, by a vendor cloud provisioner, the manufacturer for a serial number of the computing device and a computing device secret;
binding, in a provisioning data structure external to the computing device, the computing device secret and the serial number;
correlating, in the provisioning data structure, a customer and provisioning instructions of the customer with the serial number of the computing device;
receiving, from the computing device located at a location where the computing device is to be provisioned, a request for the provisioning instructions;
exchanging credentials between the computing device and the vendor cloud provisioner using the computing device secret and the vendor secret; and
transmitting the provisioning instructions to the computing device in response a successful exchange of credentials between the computing device and the vendor cloud provisioner and/or receiving the serial number from the computing device.

2. The method of claim 1, further comprising receiving from the customer, at the vendor cloud provisioner, the provisioning instructions for the computing device in response to verifying credentials of the customer.

3. The method of claim 1, wherein the computing device comprises a secure processor, separate from a central processing unit of the computing device, the secure processor configured to secure hardware of the computing device through integrated cryptographic keys, wherein querying the computing device for the computing device secret and exchanging credentials between the vendor cloud provisioner and the computing device comprise querying the secure processor.

4. The method of claim 3, wherein the secure processor comprises a trusted platform module (“TPM”).

5. The method of claim 1, wherein receiving the request for the provisioning instructions from the computing device is in response to the computing device being powered on at the location where the computing device is to be provisioned.

6. The method of claim 1, wherein the provisioning instructions comprise instructions to download and/or install firmware, an operating system, a software registration certificate, and/or an application.

7. The method of claim 1, wherein correlating the provisioning instructions with the serial number of the computing device occurs when the computing device is located at a location different than where the computing device was manufactured and different from the location where the computing device is to be installed.

8. The method of claim 1, further comprising correlating the serial number of the computing device with the customer.

9. The method of claim 1, wherein the location where the computing device is to be provisioned is at one of a location where the customer is installing the computing device and a location of a trusted vendor that is provisioning the computing device for the customer.

10. The method of claim 9, wherein the trusted vendor is correlated with the computing device at the vendor cloud provisioner and wherein exchanging credentials between the computing device and the vendor cloud provisioner comprises the trusted vendor providing credentials.

11. An apparatus comprising:
a processor; and
non-transitory computer readable storage media storing code, the code being executable by the processor to perform operations comprising:
storing a vendor secret on a computing device while the computing device is located at a manufacturer of the computing device;
querying, by a vendor cloud provisioner, the manufacturer for a serial number of the computing device and a computing device secret;
binding, in a provisioning data structure external to the computing device, the computing device secret and the serial number;
correlating, in the provisioning data structure, a customer and provisioning instructions of the customer with the serial number of the computing device;
receiving, from the computing device located at a location where the computing device is to be provisioned, a request for the provisioning instructions;
exchanging credentials between the computing device and the vendor cloud provisioner using the computing device secret and the vendor secret; and
transmitting the provisioning instructions to the computing device in response a successful exchange of credentials between the computing device and the vendor cloud provisioner and/or receiving the serial number from the computing device.

12. The apparatus of claim 11, the operations further comprising receiving from the customer, at the vendor cloud provisioner, the provisioning instructions for the computing device in response to verifying credentials of the customer.

13. The apparatus of claim 11, wherein the computing device comprises a secure processor, separate from a central processing unit of the computing device, the secure processor configured to secure hardware of the computing device through integrated cryptographic keys, wherein querying the computing device for the computing device secret and exchanging credentials between the vendor cloud provisioner and the computing device comprise querying the secure processor.

14. The apparatus of claim 11, wherein receiving the request for the provisioning instructions from the computing device is in response to the computing device being powered on at the location where the computing device is to be provisioned.

15. The apparatus of claim 11, wherein the provisioning instructions comprise instructions to download and/or install firmware, an operating system, a software registration certificate, and/or an application.

16. The apparatus of claim 11, wherein correlating the provisioning instructions with the serial number of the computing device occurs when the computing device is located at a location different than where the computing device was manufactured and different from the location where the computing device is to be installed.

17. The apparatus of claim 11, wherein the operations further comprise correlating the serial number of the computing device with the customer.

18. The apparatus of claim 11, wherein the location where the computing device is to be provisioned is at one of a location where the customer is installing the computing device and a location of a trusted vendor that is provisioning the computing device for the customer, wherein the trusted vendor is correlated with the computing device at the vendor cloud provisioner and wherein exchanging credentials between the computing device and the vendor cloud provisioner comprises the trusted vendor providing credentials.

19. A program product comprising a non-transitory computer readable storage medium storing code, the code being configured to be executable by a processor to perform operations comprising:
storing a vendor secret on a computing device while the computing device is located at a manufacturer of the computing device;
querying, by a vendor cloud provisioner, the manufacturer for a serial number of the computing device and a computing device secret;
binding, in a provisioning data structure external to the computing device, the computing device secret and the serial number;
correlating, at the vendor cloud provisioner, a customer and provisioning instructions of the customer with the serial number of the computing device;
receiving, from the computing device located at a location where the computing device is to be provisioned, a request for the provisioning instructions;
exchanging credentials between the computing device and the vendor cloud provisioner using the computing device secret and the vendor secret; and
transmitting the provisioning instructions to the computing device in response a successful exchange of credentials between the computing device and the vendor cloud provisioner and/or receiving the serial number from the computing device.

20. The program product of claim 19, the operations further comprising receiving from the customer, at the vendor cloud provisioner, the provisioning instructions for the computing device in response to verifying credentials of the customer.
